(19) United States
(12) Patent Application Publication
(10) Pub. No.: US 2005/0091888 A1
(43) Pub. Date: May 5, 2005

(54) License plate lock

(76) Inventor: Frederick L. Hoyle JR., Pickerington, OH (US)

Correspondence Address: JACOBSON HOLMAN PLLC, 400 SEVENTH STREET N.W., SUITE 600, WASHINGTON, DC, 20004, US

(21) Appl. No.: 10/699,888

(22) Filed: Nov. 4, 2003

(51) Int. Cl. G09F 7/00

(52) U.S. Cl. 40/201

(57) ABSTRACT

A license plate lock having a rectangular back bar for mounting over the front face of a license plate, a lock mounted on the back bar, a rectangular front bar for installation over the back bar, a catch mechanism on the back bar for engaging the lock in its locked position, and relatively slidable rails on the back and front bars configured to permit the front bar to slide relative to the back bar along its longitudinal axis. The back bar has a pair of apertures therethrough dimensioned and spaced for receiving standard fasteners used to affix a vehicle license plate to a standard vehicle license plate holder, the front bar covering the fasteners when installed over the back bar. The rails comprise pairs of opposed, spaced fingers sized and configured to permit the front bar to fit over the back bar with the fingers of the front and back bars in relative sliding engagement.

### FIELD OF THE INVENTION

The invention relates to locks for vehicle license plates.

### BACKGROUND OF THE INVENTION

Conventional automobiles have fairly standardized license plate support mechanisms. As shown in FIG. 1, the front and back license plates 12 are attached respectively to the front and back of the vehicle, using two to four fasteners 14 provided through four standard spaced holes found in the plates and the support mechanisms. The fasteners used are usually bolts that engage either a large structure supported by the vehicle, or some accommodation on the auto body such as a plastic insert or threaded clip. Some users may also have a license plate frame, which is also supported by the same fasteners that attach the license plate to the vehicle. Whether or not a frame is used, in most cases, the heads of the bolts are exposed directly. Exposed heads invite and facilitate the theft of the license plates.

A number of license plate locks exist in the prior art. For example, U.S. Pat. No. 6,305,107 to Parenti and U.S. Pat. No. 2,005,703 to Endlich teach license plate security devices using a sliding bar, and Parenti, U.S. Pat. No. 5,983,539 to Martin et al., U.S. Pat. No. 5,979,339 to Smith, U.S. Pat. No. 5,659,986 to Simmons, U.S. Pat. No. 5,404,664 to Brooks et al., U.S. Pat. No. 5,392,619 to Dunaway, U.S. Pat. No. 4,182,062 to Krokos et al., U.S. Pat. No. 2,776,507 to Stombock, and U.S. Pat. No. 2,710,475 to Salzmann teach license plate security devices with a back or base member fixable to the upper edge of the license plate using the license plate bolts. A number of the foregoing patents teach the use of a cylinder lock with a locking arm or cam that engages some type of latch mechanism.

However, the prior art does not provide a license plate security device that is easy to install on the license plate, allows ready access to the license plate and screws when in the inoperative state, is easy to operate, and also does not obscure the license plate in both an operative and inoperative state. In many cases, the license plate actually must be removed from the vehicle and then reinstalled with the security device.

It is to the solution of these and other objects to which the present invention is directed.

### BRIEF SUMMARY OF THE INVENTION

It is therefore a primary object of the present invention to provide a vehicle license plate lock that is installed on the front face of the license plate.

It is another object of the present invention to provide a vehicle license plate lock that is easy to operate, and also does not obscure the license plate in both an operative and inoperative state.

These and other objects of the invention are achieved by the provision of a license plate lock comprising a substantially rectangular back bar for mounting over the front face of a license plate, the back bar having opposed long first and second edges, a lock mounted on the back bar, the lock being movable between a locked and an unlocked position, a substantially rectangular front bar for installation over the back bar, engagement means on the back bar for engaging the lock when the lock is in the locked position, and relatively slidable rails on the back and front bars configured to permit the front bar to slide relative to the back bar along its longitudinal axis.

In one aspect of the invention, the back bar has a pair of apertures therethrough dimensioned and spaced for receiving standard fasteners used to affix a vehicle license plate to a standard vehicle license plate holder, the front bar covering the fasteners when installed over the back bar.

In one aspect of the invention, the rails comprise pairs of opposed, spaced fingers sized and configured to permit the front bar to fit over the back bar with the fingers of the front and back bars in relative sliding engagement.

In another aspect of the invention, the back bar comprises a substantially rectangular back wall having front and back faces, opposed long first and second edges, and opposed short third and fourth edges; opposed first and second side walls extending outwardly from the back wall at the long first and second edges, and an open front, the front bar comprises a substantially rectangular front wall having front and back faces, opposed long first and second edges, and opposed short third and fourth edges, opposed first and second side walls extending outwardly from the front wall at the long first and second edges, and an open back, and the rails comprise have pairs of opposed, spaced fingers angling outwardly from the first and second side walls of the back bar and pairs of opposed, spaced fingers angling inwardly from the first and second side walls of the front bar.

In still another aspect of the invention, the back bar further comprises opposed third and fourth side walls extending outwardly from the back wall at the short third and fourth edges, and the front bar a third side wall extending outwardly from the front wall at the short third edge.

Other objects, features and advantages of the present invention will be apparent to those skilled in the art upon a reading of this specification including the accompanying drawings.

### BRIEF DESCRIPTION OF THE DRAWINGS

The invention is better understood by reading the following Detailed Description of the Preferred Embodiments with reference to the accompanying drawing figures, in which like reference numerals refer to like elements throughout, and in which:

FIG. 1 is a front, partial elevational view of a conventional license plate with mounting screws.

FIG. 2 is a front elevational view of the back bar of a license plate lock in accordance with the present invention installed on the conventional license plate of FIG. 1.

FIG. 3 is a front elevational view of the front bar of a license plate lock in accordance with the present invention installed on the back bar of FIG. 2.

FIG. 4 is a front elevational view of the back bar of a license plate lock in accordance with the present invention.

FIG. 5 is a side elevational view of the back bar of FIG. 4.

FIG. 6 is a back elevational view of the back bar of FIG. 4.

FIG. 7 is a first side elevational view of the back bar of FIG. 4.

FIG. 8 is an opposite side elevational view of the back bar of FIG. 4.

FIG. 9 a front elevational view of the front bar of a license plate lock in accordance with the present invention.

FIG. 10 is a back elevational view of the front bar of FIG. 9.

FIG. 11 is a first side elevational view of the front bar of FIG. 9.

FIG. 12 is an opposite side elevational view of the front bar of FIG. 9.

FIG. 13 is a back elevational view of the front bar in position for installation over the back bar.

FIG. 14 is a top plan view of the front bar installed over the back bar.

FIG. 15 is a back elevational view of the front bar installed over the back bar as shown in FIG. 14.

FIG. 16 is a cross-sectional view taken along line 16-16 of FIG. 14.

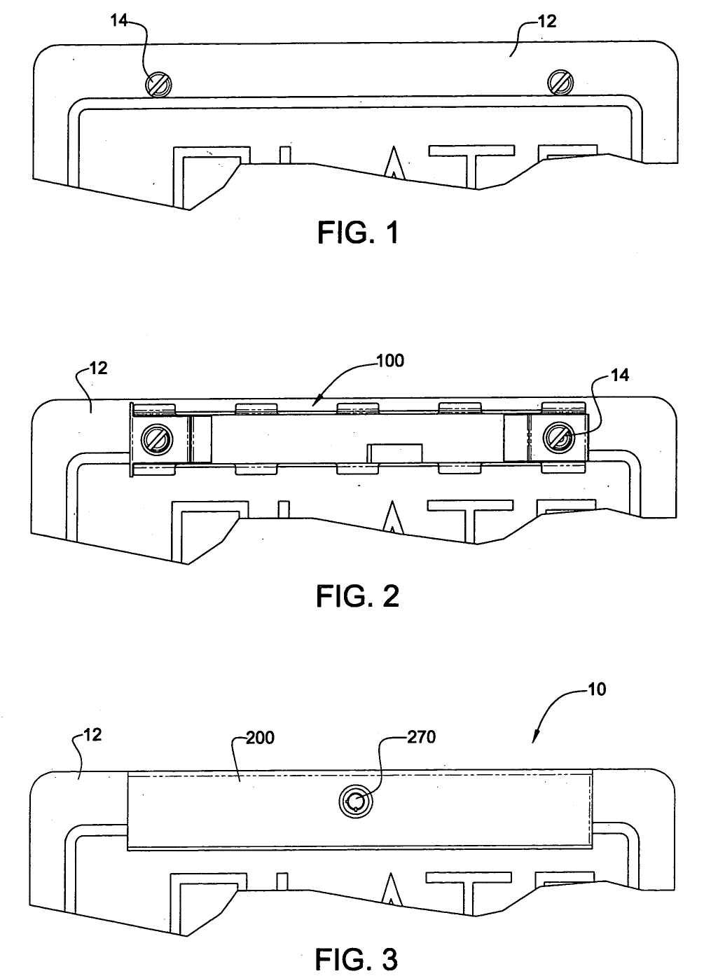

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

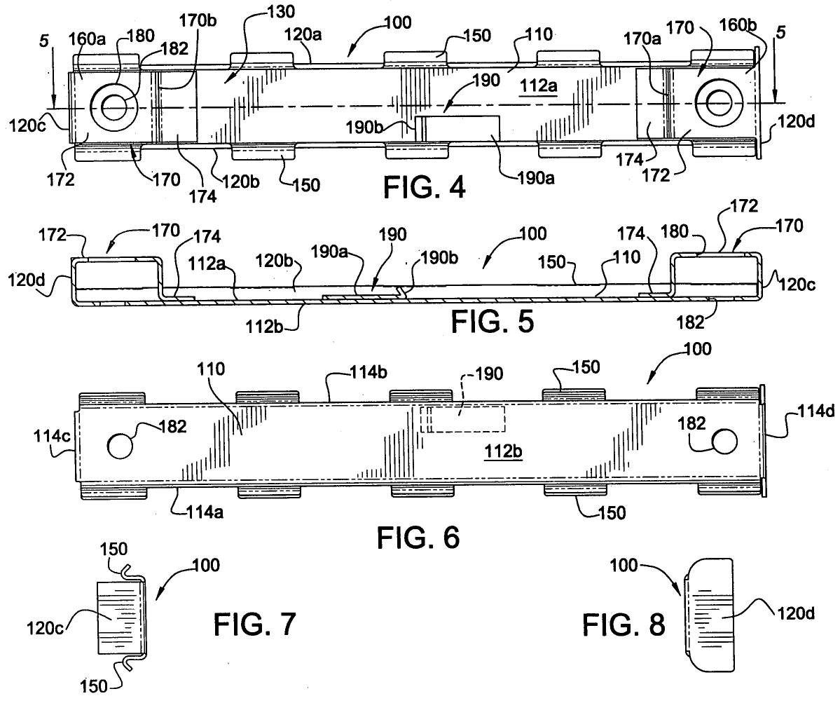

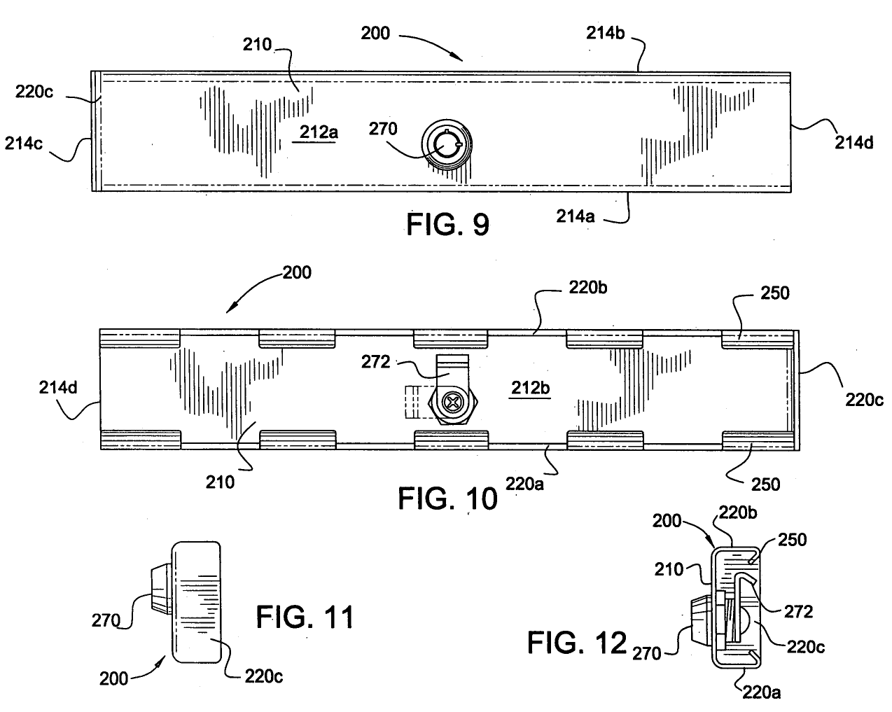

Referring now to FIGS. 2-16, there is shown a license plate lock 10 in accordance with the present invention. The license plate lock 10 comprises a back bar 100 for mounting over the front face of a license plate 12 at the upper edge and a front bar 200 for installation over the back bar 100.

The back bar 100 comprises a substantially rectangular back wall 110 having front and back faces 112a, 112b, opposed long first and second edges 114a, 114b, and opposed short third and fourth edges 114c, 114d; opposed first and second side walls 120a, 120b extending outwardly from the back wall 110 at the long first and second edges 114a, 114b, respectively; opposed third and fourth side walls 120c, 120d extending outwardly from the back wall 110 at the short third and fourth edges 114c, 114d, respectively; and an open front. The back wall 110, the first and second side walls 120a, 120b, and the third and fourth side walls 120c, 120d thus define a back bar cavity 130.

The free edges of the first and second side walls 120a, 120b have pairs of opposed, spaced fingers 150 formed integrally therewith, and which angle outwardly therefrom so as to have, in conjunction with their adjacent side walls 120a, 120b, mirror-image, substantially J-shaped profiles, for a purpose to be described hereinafter.

The third and fourth side walls 120c, 120d are substantially higher than the first and second side walls 120a, 120b, for a purpose to be described hereinafter. Also, the third side wall 120c has a width approximately equal to the inner distance between the first and second side walls 120a, 120b, while the fourth side wall has a width approximately equal to the distance between the outer edges of the fingers 150 extending from the first and second walls, also for a purpose to be described hereinafter.

Extensions of the third and fourth side walls 120c, 120d are bent into the cavity 130 to define a pair of fastener receptacles 170 adjacent the third and fourth side walls 120c, 120d. The back, first and second side, and third and fourth side walls 110, 120a, 120b, 120c, 120d, and the pair of fastener receptacles 170 preferably are formed of a single piece of metal, and thus are unitary in construction.

The fastener receptacles 170 have respective front walls 172, which are parallel to the back wall 110 of the back bar 100, and inner walls 174. Inner walls 174 preferable are L-shaped, permitting them to be joined to the back bar 100, for example by welding, The front walls 172 of the fastener receptacles 170 and the back wall 110 of the back bar 100 have respective aligned apertures 180, 182 therethrough dimensioned and spaced for receiving standard bolts used to affix a vehicle license plate 12 to a standard vehicle license plate holder. Preferably, the placement of the apertures 180 in the fastener receptacles 170 and the apertures 182 in the back wall 110 are symmetric about both the longitudinal and transverse axes of the back wall 110, so that, as described in greater detail hereinafter, the back bar 100 can be mounted over a vehicle license plate 12 with either of the long first or second edges 114a, 114b facing up.

A catch plate 190 is provided adjacent the second side wall 120b. The catch plate 190 is hook-shaped, with a planar portion 190a parallel and affixed to the front face 112a of the back wall 110 (for example, by welding) and a catch portion 190b that extends at an acute angle to the planar portion 190a.

The front bar 200 comprises a substantially rectangular front wall 210 having front and back faces 212a, 212b, opposed long first and second edges 214a, 214b, and opposed short third and fourth edges 214c, 214d; opposed first and second side walls 220a, 220b extending outwardly from the front wall 210 at the long first and second edges 214a, 214b, respectively; and a third side wall 220c extending outwardly from the front wall 210 at the short third edge 214c. The fourth side at the fourth short edge 214d is open, and the back is open. The front wall 210 and the first, second, and third side walls 220a, 220b, 220c define a front bar cavity 230. The front wall 210 and the first, second, and third side walls 220a, 220b, 220c preferably are formed of a single piece of metal, and thus are unitary in construction.

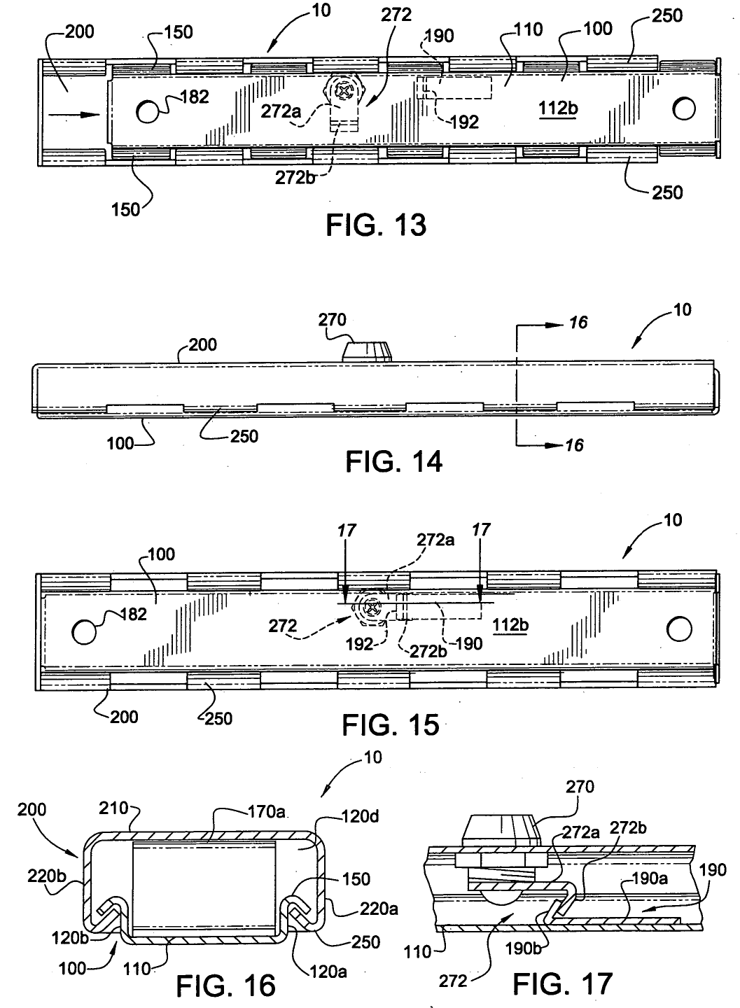

As best seen from FIGS. 13 and 15, the inner distance between the first and second side walls 220a, 220b is slightly greater than the distance between the outer edges of the fingers 150 extending from the first and second walls of the back bar 100. The first, second, and third side walls 220a, 220b, 220c are of equal height, and are substantially the same height as the third and fourth side walls 120c, 120d of the back bar 100. Also, the third side wall 220c has a width approximately equal to the outer distance between the first and second side walls 220a, 220b. It will thus be appreciated that the front bar 200 is configured and dimensioned to receive the back bar 100 substantially within the front bar cavity 230, the open fourth end of the front bar 200 permitting relative sliding movement of the back and front bars 100 and 200.

The free edges of the first and second side walls 220a, 220b have pairs of opposed, spaced fingers 250 formed integrally therewith, and which angle inwardly into the cavity so as to have, in conjunction with their adjacent side walls, mirror-image, substantially J-shaped profiles. The front bar fingers 250 are complementary in shape and size to the fingers 150 of the back bar 100; that is, they have substantially the same width and spacing as the fingers 150 of the back bar 100, and are sized and configured so that when the front bar 200 is placed over the back bar 100 with its fingers 250 in the spaces between the fingers 150 of the back bar 100, the back bar 100 fits within the front bar 200 with the fingers 250 of the front bar 200 positioned for sliding engagement with the fingers 150 of the back bar 100. As will be appreciated, the fingers 150 and 250 function as interengaging, relatively slidable rails that permit the front bar 200 to slide relative to the back bar 100 along its longitudinal axis.

The front wall 210 of the front bar 200 is provided with a lock 270, which, relative to the short third and fourth edges 214c, 214d is substantially centered, but which relative to the long first and second edges 214a and 21b4 is offset towards the long second edge 214b. The lock 270 is a rotatable, keyed lock, such as a simple cylinder lock, provided with a cam 272 at the end, such that rotation of the lock 270 by a key causes rotation of the cam 272 between an unlocked position, in which it is disengaged from the catch plate 190 when the front bar 200 is installed on the back bar 100, and a locked position, in which it engages the catch plate 190 when the front bar 200 is installed on the back bar 100.

The cam 272 is hook-shaped, with a planar portion 272a parallel to the front wall 210, and a catch portion 272b forming an acute angle with the planar portion 272a. The angle that the catch portion 190b of the catch plate 190 forms with the planar portion 190a is substantially equal to the angle that the catch portion 272b forms with the planar portion 272a, so that the catch portion 272b of the cam 272 and the catch portion 190b of the catch plate 190 are substantially parallel and engage each other when the lock 270 is in the locked position. The acute angles of the hooked portions 190b and 272b provide a configuration that is stronger in shear pull than one in which they are merely perpendicular.

The lock 270 and the catch plate 190 are positioned relative to each other such that the cam 272 can move back and forth past the catch plate 190 when the cam 272 is in the unlocked position, but the catch portion 272b is engaged by the catch portion 190b when the cam 272 is in the locked position.

Modifications and variations of the above-described embodiments of the present invention are possible, as appreciated by those skilled in the art in light of the above teachings. For example, (insert any alternatives or possible modifications here). It is therefore to be understood that, within the scope of the appended claims and their equivalents, the invention may be practiced otherwise than as specifically described. Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

1. A license plate lock comprising:
a substantially rectangular back bar for mounting over the front face of a license plate, the back bar having opposed long first and second edges;
a lock mounted on the back bar, the lock being movable between a locked and an unlocked position;
a substantially rectangular front bar for installation over the back bar;
engagement means on the back bar for engaging the lock when the lock is in the locked position; and
relatively slidable rails on the back and front bars configured to permit the front bar to slide relative to the back bar along its longitudinal axis.

2. The license plate lock of claim 1, wherein the back bar has a pair of apertures therethrough dimensioned and spaced for receiving standard fasteners used to affix a vehicle license plate to a standard vehicle license plate holder, the front bar covering the fasteners when installed over the back bar.

3. The license plate lock of claim 1, wherein the rails comprise pairs of opposed, spaced fingers.

4. The license plate lock of claim 1, wherein the front bar is dimensioned to fit over the back bar.

5. The license plate lock of claim 1, wherein:
the back bar comprises a substantially rectangular back wall having front and back faces, opposed long first and second edges, and opposed short third and fourth edges; opposed first and second side walls extending outwardly from the back wall at the long first and second edges, and an open front;
the front bar comprises a substantially rectangular front wall having front and back faces, opposed long first and second edges, and opposed short third and fourth edges, opposed first and second side walls extending outwardly from the front wall at the long first and second edges, and an open back; and
the rails comprise complementary sets of pairs of opposed, spaced fingers extending from the first and second side walls of the back bar and from the first and second side walls of the front bar.

6. The license plate lock of claim 5, wherein one set of fingers angles outwardly from the first and second side walls of the back bar and the other set of fingers angles inwardly from the first and second side walls of the front bar.

7. The license plate lock of claim 5, wherein:
the back bar further comprises opposed third and fourth side walls extending outwardly from the back wall at the short third and fourth edges; and
the front bar comprises a third side wall extending outwardly from the front wall at the short third edge.

8. A license plate lock comprising:
fixed means for mounting over the front face of a license plate using standard fasteners used to affix a vehicle license plate to a standard vehicle license plate holder;
cover means for covering the fixed means and the standard fasteners, the cover means being slidable relative to the fixed means between a first position in which one of the standard fasteners is exposed and a second position in which the standard fasteners are covered by the cover means; and
locking means for locking the cover means in the second position.
